(19) United States
(12) Patent Application Publication
(10) Pub. No.: US 2026/0051982 A1
(43) Pub. Date: Feb. 19, 2026

(54) Method and Apparatus for Dynamic On-Off Operation for Multiple Transmission and Reception (mTRP) in Wireless Communication

(71) Applicant: Apple Inc., Cupertino, CA (US)

(72) Inventors: Hong HE, San Jose, CA (US); Dawei ZHANG, Saratoga, CA (US); Wei ZENG, Saratoga, CA (US); Chunxuan YE, San Diego, CA (US); Seyed Ali Akbar FAKOORIAN, San Diego, CA (US); Jie CUI, San Jose, CA (US)

(21) Appl. No.: 19/102,965

(22) PCT Filed: Aug. 10, 2023
(86) PCT No.: PCT/US2023/029982

§ 371 Date: Feb. 11, 2025

Related U.S. Application Data
(60) Provisional application No. 63/371,102, filed on Aug. 11, 2022.

(51) Int. Cl. H04L 5/00; H04W 72/23

(52) U.S. Cl. CPC H04L 5/0035; H04W 72/23

(57) ABSTRACT

A user equipment (UE) configured to decode, based on signals received from at least a first transmission reception point (TRP) of a base station, one or more downlink signals and decode, based on signals received from the base station, downlink control information (DCI) indicating that the base station has dynamically switched between single TRP (sTRP) operation and multi-TRP (mTRP) operation.

### PRIORITY/INCORPORATION BY REFERENCE

This application claims priority to U.S. Provisional Application Ser. No. 63/371,102 filed on Aug. 11, 2022, and entitled “Method and Apparatus for Dynamic On-Off Operation for Multiple Transmission and Reception (mTRP) in Wireless Communication,” the entirety of which is incorporated herein by reference.

### BACKGROUND

A user equipment (UE) may connect to a network via a base station. Typically, energy saving techniques that are implemented on the network side and/or the UE side are designed to conserve power at the UE. However, energy consumption is also a concern on the network side and techniques designed to mitigate network power consumption may also be utilized.

The network may utilize different types of power saving techniques that include dynamically switching on and off one or more network components. For example, the base station may control multiple transmission and reception points (TRPs). The base station may dynamically switch between multi-TRP (mTRP) operation and single TRP (sTRP) operation. It has been identified that there is a need for techniques configured to enable the UE to determine when the network has dynamically switched between mTRP and sTRP operation to support the implementation of this type of network power saving technique.

### SUMMARY

Some exemplary embodiments are related to an apparatus of a user equipment (UE), the apparatus having processing circuitry configured to decode, based on signals received from at least a first transmission reception point (TRP) of a base station, one or more downlink signals and decode, based on signals received from the base station, downlink control information (DCI) indicating that the base station has dynamically switched between single TRP (sTRP) operation and multi-TRP (mTRP) operation.

Other exemplary embodiments are related to a processor configured to decode, based on signals received from at least a first transmission reception point (TRP) of a base station, one or more downlink signals and decode, based on signals received from the base station, downlink control information (DCI) indicating that the base station has dynamically switched between single TRP (sTRP) operation and multi-TRP (mTRP) operation.

Still further exemplary embodiments are related to an apparatus of a base station, the apparatus having processing circuitry configured to configure transceiver circuitry to transmit one or more downlink signals to a user equipment (UE) from at least a first transmission reception point (TRP) of the base station and configure transceiver circuitry to transmit downlink control information (DCI) to the UE, the DCI indicating that the base station has dynamically switched between single TRP (sTRP) operation and multi-TRP (mTRP) operation.

Additional exemplary embodiments are related to a processor configure transceiver circuitry to transmit one or more downlink signals to a user equipment (UE) from at least a first transmission reception point (TRP) of the base station and configure transceiver circuitry to transmit downlink control information (DCI) to the UE, the DCI indicating that the base station has dynamically switched between single TRP (sTRP) operation and multi-TRP (mTRP) operation.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows an exemplary base station according to various exemplary embodiments.

FIG. 4 shows a method for dynamic switching between multi-transmission reception point (mTRP) and single-TRP (sTRP) operation according to various exemplary embodiments.

FIG. 5 shows an exemplary deployment scenario according to various exemplary embodiments.

FIG. 6a shows an exemplary table according to various exemplary embodiments.

FIG. 6b shows an exemplary downlink control information (DCI) format 2_Y according to various exemplary embodiments.

FIG. 7 shows an exemplary DCI format 2_Y according to various exemplary embodiments.

FIG. 8 shows an example of operating a TrpSwitchTimer and corresponding UE behavior according to various exemplary embodiments.

### DETAILED DESCRIPTION

The exemplary embodiments may be further understood with reference to the following description and the related appended drawings, wherein like elements are provided with the same reference numerals. The exemplary embodiments relate to network power saving. As will be described in more detail below, the exemplary techniques introduced herein may be used to mitigate the impact of certain types of network power saving mechanisms on user equipment (UE) and/or network performance.

The exemplary embodiments are described with regard to a UE. However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

The exemplary embodiments are also described with regard to a fifth generation (5G) New Radio (NR) network and a next generation node B (gNB). However, reference to a 5G NR network and a gNB is merely provided for illustrative purposes. The exemplary embodiments may be utilized with any appropriate type of network and base station.

The gNB may be configured with multiple transmission and reception points (TRPs). Throughout this description, a TRP generally refers to a set of components configured to transmit and/or receive a beam. In some embodiments, multiple TRPs may be deployed locally at the gNB. For example, the gNB may include multiple antenna arrays/panels that are each configured to generate a different beam. In other embodiments, multiple TRPs may be deployed at various different locations and connected to the gNB via a backhaul connection. For example, multiple small cells may be deployed at different locations and connected to the gNB. However, these examples are merely provided for illustrative purposes. Those skilled in the art will understand that TRPs are configured to be adaptable to a wide variety of different conditions and deployment scenarios. Thus, any reference to a TRP being a particular network component or multiple TRPs being deployed in a particular arrangement is merely provided for illustrative purposes. The TRPs described herein may represent any type of network component configured to transmit and/or receive a beam.

The network may support multi-TRP (mTRP) based transmission. From the perspective of the UE, mTRP operation may include establishing and maintaining a connection with multiple TRPs at the same time. For example, different channel state information (CSI)-reference signals (RS) resource sets may be configured for different TRPs to support CSI measurement. It has been identified that in some scenarios it may be beneficial to switch between mTRP based transmission and single TRP (sTRP) based transmission for network power saving.

According to some aspects, the exemplary embodiments introduce techniques that enable the UE to determine when the network has dynamically switched between mTRP and sTRP operation to support the implementation of this type of network power saving technique. The exemplary techniques introduced herein may be used independently from one another, in conjunction with other currently implemented mechanisms for switching between mTRP and sTRP operation, future implementations of mechanisms for switching between mTRP and sTRP operation or independently from other mechanisms for switching between mTRP and sTRP operation.

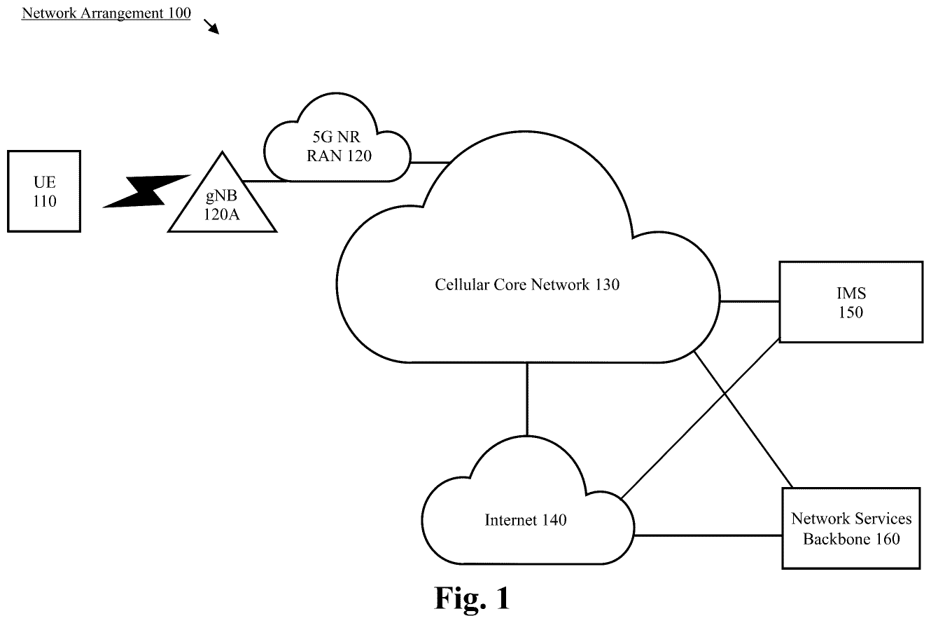

FIG. 1 shows an exemplary network arrangement 100 according to various exemplary embodiments. The exemplary network arrangement 100 includes a UE 110. Those skilled in the art will understand that the UE 110 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the exemplary embodiments, the UE 110 may establish a connection with the 5G NR RAN 120. Therefore, the UE 110 may have at least a 5G NR chipset to communicate with the 5G NR RAN 120.

The 5G NR RAN 120 may be a portion of a cellular network that may be deployed by a network carrier (e.g., Verizon, AT&T, T-Mobile, etc.). The 5G NR RAN 120 may include, for example, base stations or access nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

In the network arrangement 100, the 5G NR RAN 120 deploys a gNB 120A. The gNB 120A may be configured with multiple TRPs. Each TRP may represent one or more components configured to transmit and/or receive a signal. In some embodiments, multiple TRPs may be deployed locally at the gNB 120A. In other embodiments, multiple TRPs may be distributed at different locations and connected to the gNB 120A via a backhaul connection. For example, multiple small cells may be deployed at different locations and connected to the gNB 120A. However, these examples are merely provided for illustrative purposes. Those skilled in the art will understand that TRPs are configured to be adaptable to a wide variety of different conditions and deployment scenarios. Thus, any reference to a TRP being a particular network component or multiple TRPs being deployed in a particular arrangement is merely provided for illustrative purposes. The TRPs described herein may represent any type of network component configured to transmit and/or receive a beam. As indicated above, in some examples, the terms “TRP” and “cell” may be used interchangeably to generally refer to the same connection and/or node.

Those skilled in the art will understand that any association procedure may be performed for the UE 110 to connect to the 5G NR RAN 120. For example, as discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer an interconnected set of components that manages the operation and traffic of the cellular network. It may include the evolved packet core (EPC) and/or the 5G core (5GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

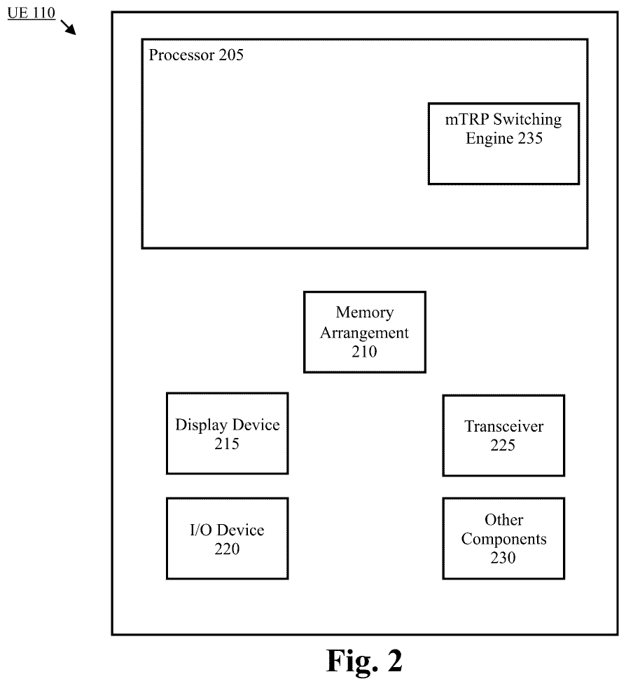

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a mTRP switching engine 235. The mTRP switching engine 235 may perform various operations related to determining whether the network has changed a number of TRPs transmitting to the UE 110. To provide some general examples, the mTRP switching engine 235 may perform operations such as, but not limited to, receiving DCI and operating a timer configured to control a timer duration during which the UE 110 is to consider a specific TRP to be active.

The above referenced engine 235 being applications (e.g., a program) executed by the processor 205 is merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engine may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G NR-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies). The transceiver 225 may encompass an advanced receiver (e.g., E-MMSE-RC, R-ML, etc.) for MU-MIMO. The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

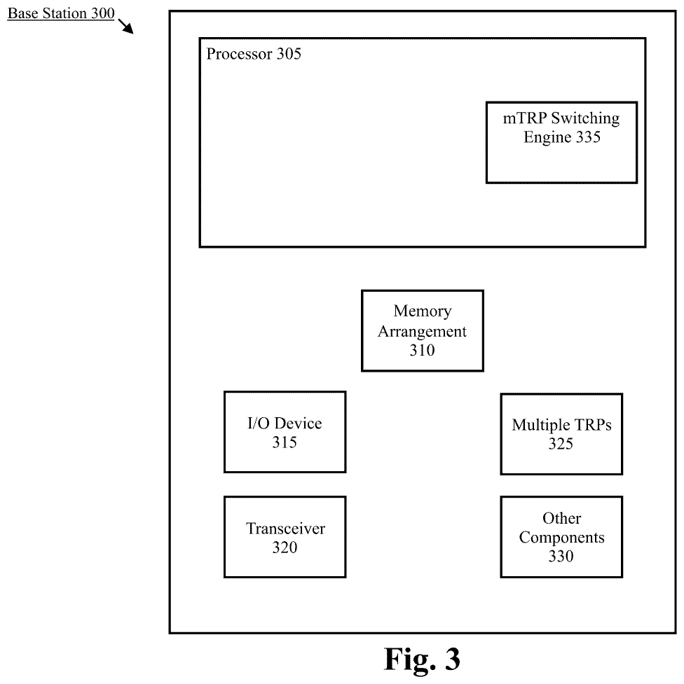

FIG. 3 shows an exemplary base station 300 according to various exemplary embodiments. The base station 300 may represent the gNB 120A or any other type of access node through which the UE 110 may establish a connection and manage network operations.

The base station 300 may include a processor 305, a memory arrangement 310, an input/output (I/O) device 315, a transceiver 320, multiple TRPs 325 and other components 330. The other components 3330 may include, for example, an audio input device, an audio output device, a battery, a data acquisition device, ports to electrically connect the base station 300 to other electronic devices and/or power sources, TxRUs, transceiver chains, antenna elements, antenna panels, etc.

As indicated above, in some scenarios, the multiple TRPs 330 may be deployed locally at the base station 300. In other scenarios, one or more of the multiple TRPs may be deployed at physical locations remote from the base station 300 and connected to the base statin via a backhaul connection. The base station 300 may be configured to control the multiple TRPs 330 and perform operations such as, but not limited to, assigning resources, configuring reference signals, implementing beam management techniques, etc.

The processor 305 may be configured to execute a plurality of engines for the base station 300. For example, the engines may include a mTRP switching engine 335. The mTRP switching engine 335 may perform various operations related to determining whether the network has changed a number of TRPs transmitting to the UE 110. To provide some general examples, the mTRP switching engine 335 may perform operations such as, but not limited to, transmitting DCI indicating to one or more UEs whether a specific TRP is active for the one or more UEs.

The above noted engine 335 being an application (e.g., a program) executed by the processor 305 is only exemplary. The functionality associated with the engine 335 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some base stations, the functionality described for the processor 305 is split among a plurality of processors (e.g., a baseband processor, an applications processor, etc.). The exemplary embodiments may be implemented in any of these or other configurations of a base station.

The memory 310 may be a hardware component configured to store data related to operations performed by the base station 300. The I/O device 315 may be a hardware component or ports that enable a user to interact with the base station 300.

The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

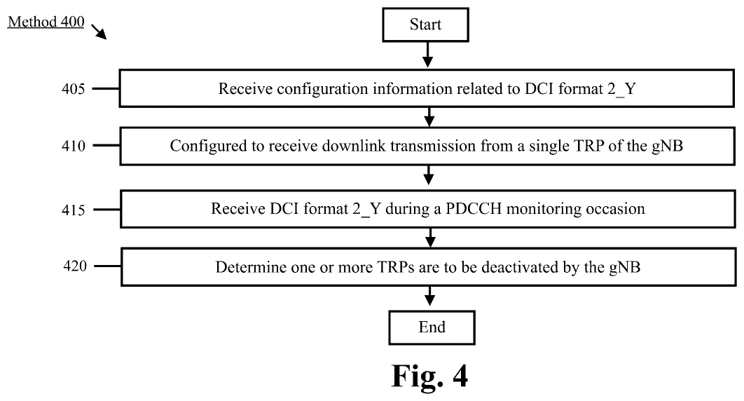

According to some aspects, the exemplary embodiments related to a network power saving technique where the base station dynamically switches between mTRP and sTRP operation. As will be described in more detail below, the exemplary embodiments introduce a group common DCI that may be used to indicate dynamic switching between mTRP and sTRP operation. Throughout this description, this exemplary DCI may be referred to as DCI format 2_Y. However, reference to DCI format 2_Y is merely provided for illustrative purposes, the 2_Y classification provided herein may serve as a placeholder. In an actual deployment scenario, the new DCI format may be assigned any other appropriate number or label instead of 2_Y. Various examples of utilizing the exemplary DCI format 2_Y are provided below with regard to FIGS. 4-8.

FIG. 4 shows a method 400 for dynamic switching between mTRP and sTRP operation according to various exemplary embodiments. The method 400 is described from the perspective of the UE 110 and is provided as a general overview of a scenario during which the exemplary techniques introduced herein may be utilized. Additional details regarding the exemplary techniques will be provided below after the description of the method 400.

In 405, the UE 110 may receive configuration information related to the DCI format 2_Y. For example, the size of the DCI format 2_Y may be configured by RRC signaling. However, the exemplary embodiments are not limited to RRC signaling and configuration information related to the DCI format 2_Y may be provided by SIB, RRC signaling, hard encoded in 3GPP specification, any combination thereof or may be provided in any other appropriate manner.

In 410, the UE 110 is configured to receive downlink transmissions from a single TRP of the gNB 120A (e.g., sTRP operation). For example, the UE 110 may be configured to receive downlink signals from a first TRP deployed by the gNB 120A.

In 415, the UE 110 receives DCI format 2_Y during a PDCCH monitoring occasion. The exemplary DCI format 2_Y may indicate which TRPs are active for the UE 110. For example, the DCI format 2_Y may indicate that a first and second TRP of the gNB 120A are configured to transmit downlink signals to the UE 110 (e.g., mTRP operation).

In some embodiments, the exemplary DCI format 2_Y may be configured with cyclic redundancy check (CRC) scrambled by a dedicated TRP-radio network temporary identifier (RNTI). However, the exemplary embodiments are not limited to CRC or TRP-RNTI. The exemplary embodiments may any appropriate scrambling techniques and any appropriate RNTI (if at all).

As will be described in more detail below after the method 400, the exemplary embodiments are described with regard to a control resource set (CORESET). Those skilled in the art will understand that a CORESET represents a set of physical resources and/or a set of parameters that may be used to carry downlink control signaling (e.g., physical downlink control channel (PDCCH), DCI, etc.). For example, the CORESET may be defined and, based on the CORESET, a search space (SS) may be defined. The UE 110 may perform PDCCH monitoring within the SS to receive downlink control signaling.

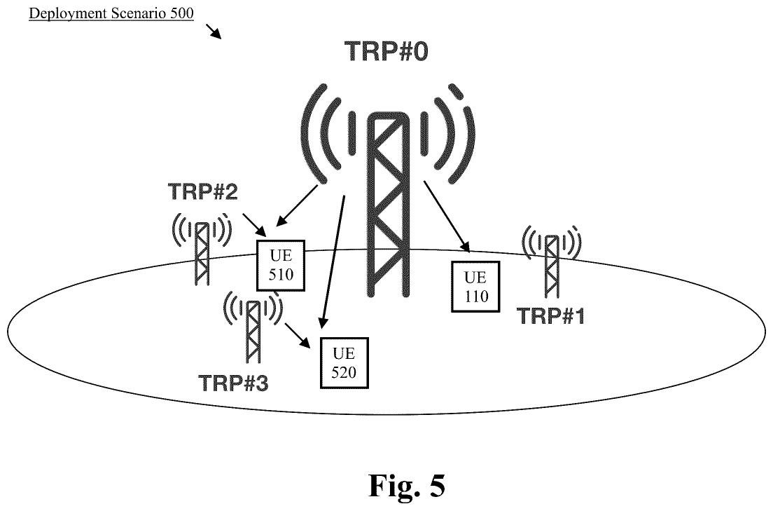

Each TRP may be scheduled by a CORESET that has a corresponding CORESETPoolIndex {0,1}. The exemplary DCI format 2_Y may include multiple Tᵢ fields. Each Tᵢ may be configured to indicate the activation/deactivation of a CORESET corresponding to a TRP of the gNB and configured with CORESETPoolIndex set to 1. When the CORESETPoolIndex is set to 0, this may indicate that the corresponding TRP is not configured for dynamic switching. Additional examples of TRP operation are provided below with regard to FIGS. 5-8.

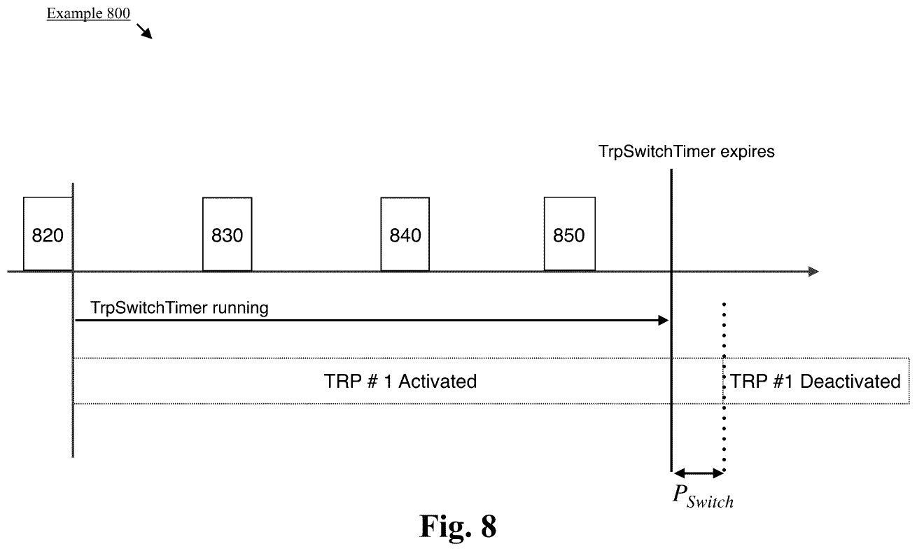

In 420, the UE 110 determines that one or more TRPs are to be deactivated by the gNB 120A. In some embodiments, the network may signal DCI format 2_Y or any other appropriate type of indication to the UE 110 that is configured to notify the UE 110 that the second TRP is to be deactivated. In other embodiments, the UE 110 may utilize a timer or any other appropriate conditions to determine that an active TRP is to be deactivated by the gNB 120A. The exemplary embodiments introduce a timer configured to control a time interval during which the UE 110 is to consider a particular TRP to be active. Upon expiry of the timer (with or without an offset), the UE 110 may consider the TRP associated with the timer to be deactivated. Throughout this description, this exemplary timer may be referred to as a TrpSwitchTimer. However, reference to the term TrpSwitchTimer is merely provided for illustrative purposes. Different entities may refer to a similar concept by a different name. Additional examples of utilizing the TrpSwitchTimer are provided below with regard to FIG. 8.

FIG. 5 shows an exemplary deployment scenario 500 according to various exemplary embodiments. In the deployment scenario 500, there are four TRPs, e.g., TRP #0, TRP #1, TRP #2 and TRP #3 and three UEs, e.g., UE 110, UE 510 and UE 520. However, reference to four TRPs and three UEs is merely provided for illustrative purposes. In an actual deployment scenario, any appropriate number of TRPs may be deployed by the network to serve any appropriate number of UEs.

During operation, an event and/or condition may occur that triggers the gNB 120A to dynamically activate or deactivate TRPs for one or more UEs. For example, during a period of low traffic load, the gNB 120A may switch from mTRP operation to single TRP operation for network power saving. However, the manner in which the gNB 120A is triggered to switch between mTRP and sTRP operation (or vice versa) is beyond the scope of the exemplary embodiments. Instead, the exemplary embodiments introduce techniques for signaling an indication of a dynamic switch from sTRP operation to mTRP operation (or vice versa) and enabling the UE 110 to determine when the dynamic switching has occurred.

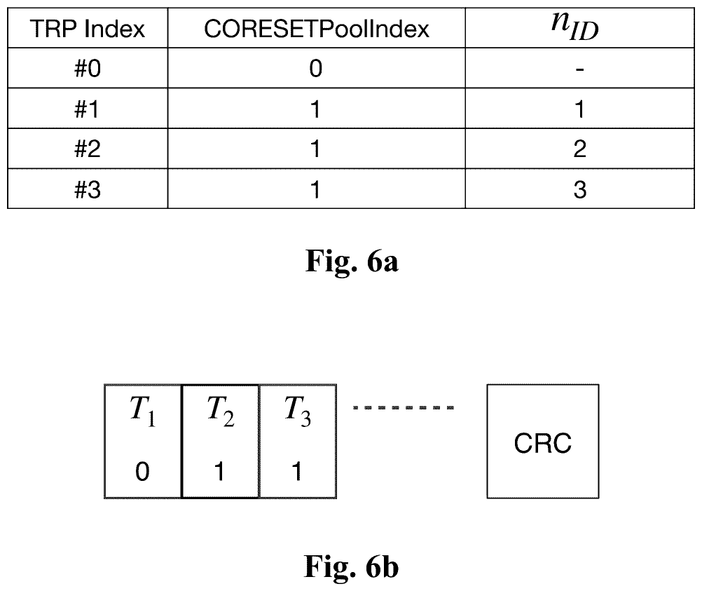

FIG. 6a shows an exemplary table 600 according to various exemplary embodiments. The table 600 comprises DCI format 2_Y parameters for enabling dynamic switching between mTRP and sTRP operation (or vice versa). The table 600 includes a TRP index associated with the multiple TRPs shown in the deployment scenario 500 (e.g., TRP #0, TRP #1, TRP #2, TRP #3), a CORESETPoolIndex corresponding to each TRP and a virtual TRP ID n_{ID}.

FIG. 6b shows an exemplary DCI format 2_Y according to various exemplary embodiments. In this example, three Tᵢ fields (T₁, T₂, T₃) are shown. As mentioned above, each Tᵢ may be configured to indicate the activation/deactivation of a CORESET configured with CORESETPoolIndex set to a first value (e.g., 1) and a n_{ID}=i. In this example, the CORESETPoolIndex for TRP #0 is shown to be 0 in the table 600 which may indicate that the corresponding TRP #0 is not configured for dynamic switching. However, reference to three Tᵢ fields are merely provided for illustrative purposes, the exemplary embodiments may be applied to a DCI format 2_Y comprising any appropriate number of Tᵢ fields.

In the table 600, T₁ corresponds to virtual TRP ID (n_{ID})=1, T₂ corresponds to virtual TRP ID (n_{ID})=2 and T₃ corresponds to virtual TRP ID (n_{ID})=3. Each of the TRPs corresponding to the three Tᵢ fields (T₁, T₂, T₃) have a corresponding CORSETPoolIndex set to a value of 1. The CORESETPoolIndex indicates that each of the corresponding TRPs are eligible for dynamic switching between mTRP and sTRP operation. When a Tᵢ field of DCI format 2_Y is set to a first value (e.g., 1) this may indicate the CORESET for the corresponding TRP shall be activated. When a Tᵢ field of DCI format 2_Y is set to a second value (e.g., 0) this may indicate the CORESET corresponding to the TRP is not active.

Returning to the deployment scenario 500, the T₁ field of the DCI format 2_Y is set to 0. Since its corresponding CORESETPoolIndex in the table 600 is set to 1, this indicates that the CORESET of TRP #1 is deactivated. Accordingly, in the deployment scenario 500, the TRP #1 is not depicted as being in communication with any of the UEs 110, 510, 520.

Continuing with the example, the T₂ field of the DCI format 2_Y is set to 1. Since its corresponding CORESETPoolIndex in the table 600 is set to 1, this indicates that the CORESET of TRP #2 is activated for one or more of the UEs 110, 510, 520. Accordingly, in the deployment scenario 500 the TRP #2 is depicted as being in communication with UE 510.

Continuing with the example, the T₃ field of the DCI format 2_Y is set to 1. Since its corresponding CORESETPoolIndex in the table 600 is set to 1, this indicates that the CORESET of TRP #3 is activated. Accordingly, in the deployment scenario 500 the TRP #3 is depicted as being in communication with UE 520.

Various different techniques may be used to associate different TRPs to a Tᵢ field in the DCI format 2_Y. In some embodiments, like the examples shown above with regard to the table 600, a virtual TRP ID (n_{ID}) may be configured for a TRP with a higher-layer parameter CORESETPoolIndex=1. As shown in the table 600, the unique ID n_{ID} may be assigned to each TRP with a CORESETPoolIndex=1. Then, each Tᵢ field in the DCI format 2_Y may be used to indicate the activation/deactivation of the TRP associated with the virtual TRP ID n_{ID}=i.

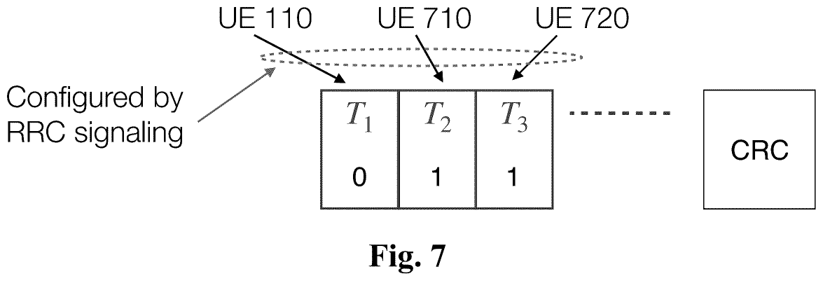

In other embodiments, the UE 110 may be configured by dedicated RRC signaling with a starting bit of a unique block field in the DCI format 2_Y that may be used for TRP switching. In this example, a UE may be assigned with one or more Tᵢ fields without utilizing the virtual TRP ID. Instead, by dynamically setting the value of each of the Tᵢ fields, the gNB 120A may control the TRP switching for network power saving. An example of this is shown in FIG. 7 where the UE 110 is configured by RRC signaling to be assigned to T₁, the UE 710 is configured by RRC signaling to be assigned to T₂ and the UE 720 is configured by RRC signaling to be assigned to T₃. As indicated above, by setting the T₁ field to 0, the gNB 120A indicates to the UE 110 that mTRP operation has been deactivated. Similarly, by setting the T₁ and T₁ fields to 1, the gNB 120A indicates that mTRP operation has been activated for the UEs 710 and 720 respectively.

As mentioned above, the UE 110 may operate a TrpSwitchTimer to determine when a TRP is to be considered deactivated. During operation, the UE 110 may be provided with configuration information related to the TrpSwitchTimer. In the examples provided below, the configuration information is characterized as being provided via RRC signaling. However, in an actual deployment scenario, the configuration information for the TrpSwitchTimer may be provided by SIB, RRC signaling, hard encoded in 3GPP specification, any combination thereof or provided in any other appropriate manner.

FIG. 8 shows an example 800 of operating the TrpSwitchTimer and corresponding UE behavior according to various exemplary embodiments. In example 800, DCI format 2_Y may be received during a PDCCH monitoring occasion 820. This triggers the UE 110 to initiate the TrpSwitchTimer. While the TrpSwitchTimer is running the UE 110 may consider the corresponding TRP (e.g., TRP #1) to be activated. When the TrpSwitchTimer expires, the UE 110 may consider the corresponding TRP to be deactivated. In this example, there is no downlink control signaling received during the PDCCH monitoring occasions 830-850 and thus, the timer is not extended or restarted. However, in an actual deployment scenario, the UE 110 may be triggered to restart or extend the duration of the TrpSwitchTimer via downlink control signaling (e.g., DCI, etc.) during PDCCH monitoring.

In some embodiments, the TrpSwitchTimer may correspond to a CORESET pool with a CORSETPoolIndex set to 1 for a serving cell or a set of serving cells. The UE 110 may decrement the timer value by one after each slot based on a reference subcarrier spacing (SCS) configuration that is the smallest SCS configuration among configured downlink bandwidth parts (BWPs) in the service cell or the set of serving cells. However, reference to a timer being operated based on a slot for a particular type of SCS is provided for illustrative purposes, the exemplary TrpSwitchTimer may utilize any appropriate unit of time.

The exemplary TrpSwitchTimer may be utilized in conjunction with an offset P_{Switch}. For example, the TRP corresponding to the TrpSwitchTimer may not be considered to be deactivated until the beginning of the first slot that is at least P_{Switch} symbols after a slot where the TrpSwitchTimer expires. An example of P_{Switch} is depicted in the example 800 of FIG. 8.

### Examples

In a first example, a method performed by a user equipment (UE), comprising receiving one or more downlink signals from at least a first transmission reception point (TRP) of a base station and receiving downlink control information (DCI) from the base station, the DCI indicating that the base station has dynamically switched between single TRP (sTRP) operation and multi-TRP (mTRP) operation.

In a second example, the method of the first example, wherein the DCI includes multiple fields, each field indicating whether a control resource set (CORESET) corresponding to a TRP is activated.

In a third example, the method of the second example, wherein the UE is assigned a subset of the multiple fields and each field in the subset is associated with a corresponding TRP.

In a fourth example, the method of the first example, wherein the base station is configured to dynamically activate multiple TRPs and each TRP corresponds to a respective CORSETPoolIndex that is set to a first value.

In a fifth example, the method of the fourth example, wherein the DCI includes multiple fields, each field corresponding to a virtual TRP ID that is configured to a TRP.

In a sixth example, the method of the first example, further comprising receiving one or more radio resource control (RRC) signals, the one or more signals indicating a starting bit of a unique block field of the DCI that is assigned to the UE corresponding to a TRP, wherein the DCI is a group common DCI.

In a seventh example, the method of the first example, further comprising initiating a timer in response to the DCI, the timer configured to control a timer interval during which a TRP is activated for the UE.

In an eighth example, the method of the seventh example, wherein the UE decrements a timer value for the timer based on a reference sub carrier spacing (SCS) configuration that is a smallest SCS configuration among all downlink bandwidth parts (BWPs) in a serving cell.

In a ninth example, the method of the seventh example, wherein the TRP is deactivated at a beginning of a slot that is at least a predetermined number of symbols after a slot where the timer expires.

In a tenth example, a processor configured to perform any of the methods of the first through ninth examples.

In an eleventh example, a user equipment (UE) comprising a transceiver configured to communicate with a network and a processor communicatively coupled to the transceiver and configured to perform any of the methods of the first through ninth examples.

In a twelfth example, a method is performed by a base station, comprising transmitting one or more downlink signals to a user equipment (UE) from at least a first transmission reception point (TRP) of the base station and transmitting downlink control information (DCI) to the UE, the DCI indicating that the base station has dynamically switched between single TRP (sTRP) operation and multi-TRP (mTRP) operation.

In a thirteenth example, the method of the twelfth example, wherein the DCI is a group common DCI format for more than one UE for switching indication between sTRP and mTRP operations.

In a fourteenth example, the method of the twelfth example, wherein the DCI includes multiple fields, each field indicating whether a control resource set (CORESET) corresponding to a TRP is activated.

In a fifteenth example, the method of the fourteenth example, wherein the UE is assigned a subset of the multiple fields and each field in the subset is associated with a corresponding TRP.

In a sixteenth example, the method of the twelfth example, wherein the base station is configured to dynamically activate multiple TRPs and each TRP corresponds to a respective CORSETPoolIndex that is set to a first value.

In a seventeenth example, the method of the sixteenth example, wherein the DCI includes multiple fields, each field corresponding to a virtual TRP ID that is configured for a TRP.

In an eighteenth example, the method of the twelfth example, further comprising transmitting one or more radio resource control (RRC) signals to the UE, the one or more signals indicating a starting bit of a unique block field of the DCI that is assigned to the UE corresponding to a TRP.

In a nineteenth example, the method of the twelfth example, further comprising initiating a timer in response to the DCI, the timer configured to control a timer interval during which a TRP is activated for the UE.

In a twentieth example, the method of the nineteenth example, further comprising, wherein the TRP is deactivated at a beginning of a slot that is at least a predetermined number of symbols after a slot where the timer expires.

In a twenty first example, a processor configured to perform any of the methods of the twelfth through twentieth examples.

In an twenty second example, a base station comprising a transceiver configured to communicate with a user equipment (UE) and a processor communicatively coupled to the transceiver and configured to perform any of the methods of the twelfth through twentieth examples.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus of a user equipment (UE), the apparatus comprising processing circuitry configured to:
decode, based on signals received from at least a first transmission reception point (TRP) of a base station, one or more downlink signals; and
decode, based on signals received from the base station, downlink control information (DCI) indicating that the base station has dynamically switched between single TRP (sTRP) operation and multi-TRP (mTRP) operation.

2. The apparatus of claim 1, wherein the DCI includes multiple fields, each field indicating whether a control resource set (CORESET) corresponding to a TRP is activated.

3. The apparatus of claim 2, wherein the UE is assigned a subset of the multiple fields and each field in the subset is associated with a corresponding TRP.

4. The apparatus of claim 1, wherein the base station is configured to dynamically activate multiple TRPs and each TRP corresponds to a respective CORSETPoolIndex that is set to a first value.

5. The apparatus of claim 4, wherein the DCI includes multiple fields, each field corresponding to a virtual TRP ID that is configured to a TRP.

6. The apparatus of claim 1, wherein the processing circuitry is further configured to:
decode, based on signals received from the base station, one or more radio resource control (RRC) signals, the one or more signals indicating a starting bit of a unique block field of the DCI that is assigned to the UE corresponding to a TRP, wherein the DCI is a group common DCI.

7. The apparatus of claim 1, wherein the processing circuitry is further configured to:
initiate a timer in response to the DCI, the timer configured to control a timer interval during which a TRP is activated for the UE.

8. The apparatus of claim 7, wherein the UE decrements a timer value for the timer based on a reference sub carrier spacing (SCS) configuration that is a smallest SCS configuration among all downlink bandwidth parts (BWPs) in a serving cell.

9. The apparatus of claim 7, wherein the TRP is deactivated at a beginning of a slot that is at least a predetermined number of symbols after a slot where the timer expires.

10. A processor configured to:
decode, based on signals received from at least a first transmission reception point (TRP) of a base station, one or more downlink signals; and
decode, based on signals received from the base station, downlink control information (DCI) indicating that the base station has dynamically switched between single TRP (sTRP) operation and multi-TRP (mTRP) operation.

11. The processor of claim 1, wherein the DCI includes multiple fields, each field indicating whether a control resource set (CORESET) corresponding to a TRP is activated.

12. An apparatus of a base station, the apparatus comprising processing circuitry configured to:
configure transceiver circuitry to transmit one or more downlink signals to a user equipment (UE) from at least a first transmission reception point (TRP) of the base station; and
configure transceiver circuitry to transmit downlink control information (DCI) to the UE, the DCI indicating that the base station has dynamically switched between single TRP (sTRP) operation and multi-TRP (mTRP) operation.

13. The apparatus of claim 12, wherein the DCI is a group common DCI format for more than one UE for switching indication between sTRP and mTRP operations.

14. The apparatus of claim 12, wherein the DCI includes multiple fields, each field indicating whether a control resource set (CORESET) corresponding to a TRP is activated.

15. The apparatus of claim 14, wherein the UE is assigned a subset of the multiple fields and each field in the subset is associated with a corresponding TRP.

16. The apparatus of claim 12, wherein the base station is configured to dynamically activate multiple TRPs and each TRP corresponds to a respective CORSETPoolIndex that is set to a first value.

17. The apparatus of claim 16, wherein the DCI includes multiple fields, each field corresponding to a virtual TRP ID that is configured for a TRP.

18. The apparatus of claim 12, wherein the processing circuitry is further configured to:
configure transceiver circuitry to transmit one or more radio resource control (RRC) signals to the UE, the one or more signals indicating a starting bit of a unique block field of the DCI that is assigned to the UE corresponding to a TRP.

19. The apparatus of claim 12, wherein the processing circuitry is further configured to:
initiate a timer in response to the DCI, the timer configured to control a timer interval during which a TRP is activated for the UE.

20. The apparatus of claim 19, wherein the TRP is deactivated at a beginning of a slot that is at least a predetermined number of symbols after a slot where the timer expires.
